(19) United States
(12) Patent Application Publication
(10) Pub. No.: US 2010/0007507 A1
(43) Pub. Date: Jan. 14, 2010

(54) Electronic eye-pointing assisted alternative and augmented communications device

(76) Inventors: Maurice William Thompson, Ross on Wye (GB); Lyndon Neil Owen, Monmouth (GB)

Correspondence Address: Maurice Thompson, 19 White Swan Court, Monmouth, NP25 3NY, GB

(21) Appl. No.: 12/218,256

(22) Filed: Jul. 14, 2008

(51) Int. Cl. G08B 7/06

(52) U.S. Cl. 340/815.69

(57) ABSTRACT

The present invention is electronic eye-pointing assisted alternative and augmented communications device that stores communicated characters in electronic memory and displays them on display panels on the device. The device has a library of phrases stored in electronic memory that can be called up and displayed using two character codes. The device can be connected to a computer to display the communicated characters on a large screen and to enable the device to be used as an input device for an application or to edit the library of phrases or change the language of use.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Ventilated surgical patients or people who have had a stroke or have multiple sclerosis, motor neurone disease, cerebral palsy, or severe spinal trauma often have impairment to speech and have temporarily or permanently lost the mobility of their hands and are therefore unable to write by hand or by using a mechanical device such as a computer keyboard have a severely limited ability to communicate with others.

Prior Art uses devices consisting of a flat panel with coloured labels on which are imprinted coloured alphanumeric characters or symbols. A method for the use of this device between a first user and a second user requires the sequential selection of labels by the detection of eye movement of the first user by the second user to communicate a series of letters which must be remembered or written down. These devices are described as eye-pointing assisted alternative and augmented communications devices.

Communication using prior art devices is very slow and one or both users quickly become fatigued. Mistakes occur if users try to memorise the characters communicated.

### BRIEF SUMMARY OF THE INVENTION

The present invention provides an electronic eye-pointing assisted alternative and augmented communications device comprising an enclosure with a central aperture or window and coloured signs on which are imprinted or displayed coloured alphanumeric characters or symbols. A method for the use of this device between a first user and a second user requires the sequential selection of the signs by the detection of eye movement of the first user by the second user to communicate a series of alphanumeric characters providing communication between the users and by the use of control switches and electronic circuits the communicated alphanumeric characters are stored in the electronic memory of the device and in one example displayed on the electronic display panels on the device, in another example displayed on a computer screen.

The present invention provides fast communication between users and provides additional functionality of automatically recording the communication. The present invention also provides a means of communicating whole phrases and sentences that are stored in a library of phrases in the electronic memory of the device and that may be selected by communicating a combination of a single alpha and a single numeric character.

The invention overcomes the problems encountered with prior art devices by providing much faster speeds of communication with less user fatigue and fewer errors.

### BRIEF DESCRIPTION OF THE SEVERAL VIEWS OF THE INVENTION

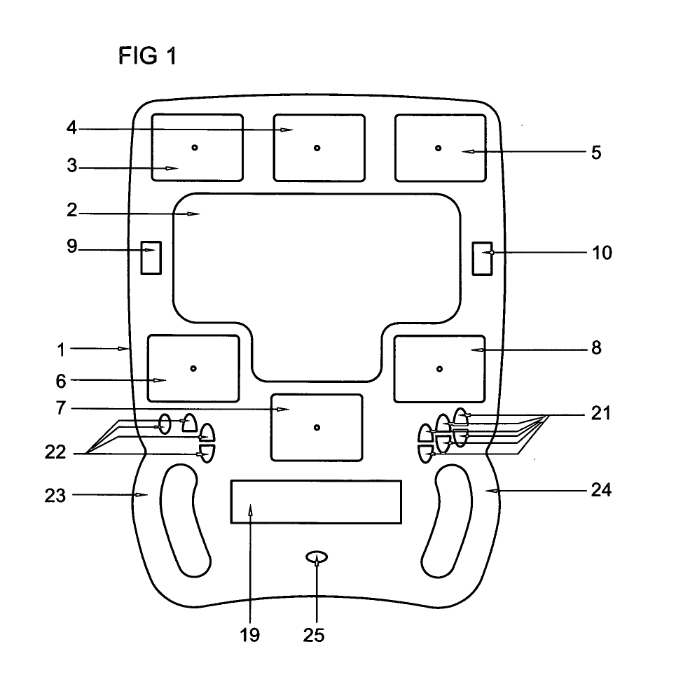

FIG. 1—View of the device as seen by a second user

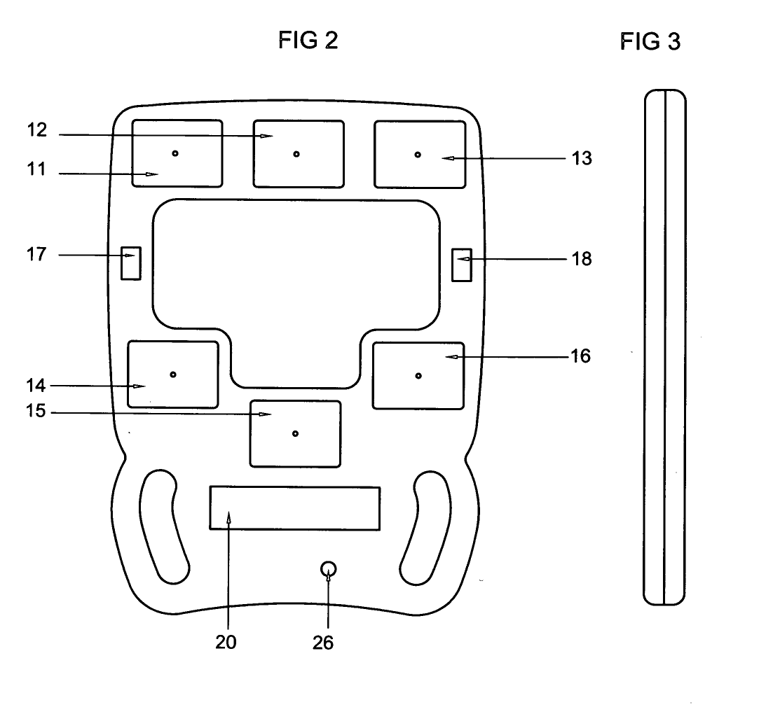

FIG. 2—View of the device as seen by a first user.

FIG. 3—a side view.

### DESCRIPTION OF THE PREFERRED EMBODIMENT

The present invention is a device that may be used for communication of symbols for example alphanumeric characters between a first user and a second user. In most applications the first user usually has impairment to speech and has temporarily or permanently lost the mobility of their hands and are therefore unable to write by hand or by using a mechanical device such as a computer keyboard have a severely limited ability to communicate with others. The second user operates the device. The device is more accurately described in the attached drawings.

The present device illustrated in FIG. 1 and FIG. 2 comprises an enclosure (1) with an aperture or window (2) around which signs (3,4,5,6,7,8,9,10,11,12,13,14,15,16,17,18) are placed attached to or visible through or projecting through the surface of the enclosure. The present device has switches (21,22,25) on or inset into or projecting through the surface of the enclosure of the device to control the operating functions of the device.

The signs are spaced in such a manner as to facilitate clear indication of any one sign by the first user to the second user by the movement of the eyes or of one eye only by the first user to look at any one sign when the device is conveniently positioned between the first user and the second user and the eyes of the first user are visible to the second user when looking through the aperture or window of the device. The positions of the signs are one at the top left hand corner of the aperture or window, one at the top right hand corner of the aperture or window one at the bottom left-hand corner of the aperture or window one at the bottom right-hand corner of the aperture or window one at the centre of the top edge of the aperture or window one at the centre of the bottom edge of the aperture or window one at the centre of the right-hand edge of the aperture or window and one at the centre of the edge of the left-hand edge of the aperture or window.

Each of the signs at the top left-hand corner, centre of the top edge, top right-hand corner, bottom left-hand corner, centre of the bottom edge and right-hand bottom corner of the aperture or window has a different colour background.

Each of the signs at the top left-hand corner, centre of the top edge, top right-hand corner, bottom left-hand corner, centre of the bottom edge and right-hand bottom corner of the aperture or window is imprinted with or displays six alpha or numeric characters each of a different colour one of which is the same colour as the background colour of the sign and which may be outlined in a contrasting colour for example black or white so that it is distinguishable against the background colour of the sign. The colours of the other five characters on each sign are the same as the colours of the background colours of the other five signs that have alpha or numeric characters imprinted or displayed on them.

The alphanumeric characters or symbols and the colours of the alphanumeric characters or symbols and the background colours shown by the signs positioned at the top left-hand corner, the top right-hand corner, the bottom left-hand corner, the bottom right-hand corner, the centre of the left-hand edge and the centre of the right-hand edge of the aperture or window as seen from the side viewed by the second user are identical to the alphanumeric characters or symbols and the colours of the alphanumeric characters or symbols shown by the signs and the background colours of the signs positioned respectively at the top right-hand corner, the top left-hand corner, the bottom right-hand corner, the bottom left-hand corner, the centre of the right-hand edge and the centre of the left-hand edge of the aperture or window as seen from the side viewed by the first user.

The alphanumeric characters or symbols and the colours of the alphanumeric characters or symbols and the background colours shown by the signs positioned at the centre of the top edge and the centre of the bottom edge of the aperture or window as seen from the side viewed by the second user are identical to the alphanumeric characters or symbols and the colours of the alphanumeric characters or symbols and the background colours shown by the signs positioned at the centre of the top edge and the centre of the bottom edge of the aperture or window as seen from the side viewed by the first user.

Each of the signs at the top left-hand corner, centre of the top edge, top right hand corner, bottom left-hand corner, centre of the bottom edge and right-hand bottom corner of the aperture or window has a selection indicator which may be switched on and off and may be for example a small lamp visible through a small window in the sign.

To facilitate the placement of the device between the first user and the second user in a convenient position for use the device has handles (23,24). The device has electronic display panels (19,20) for displaying the symbols characters and phrases communicated between the users mounted in positions so that each of the two users can clearly see one display panel when the device is held in a convenient position for use. The device has electronic circuits within the enclosure that are connected to the switches and to the display panels.

To minimise fatigue in the arms of the user the device is shaped and proportioned and the handles used for holding the device are positioned and shaped such that when the device is held in the normal position for use the arms of the user may be rested against the body of the user.

For convenience of use the device is powered by batteries within the enclosure. For convenience the batteries may be recharged without being removed from the device by connecting a suitable electrical power source to an electrical socket (26). The device may also be powered from an electrical supply connected to the electrical socket (26). The present device is equipped with a switch (25) to turn it on and off.

The switches on the current device are conveniently grouped together. Means for minimising errors is provided by placing all the switches for the selection of signs in a single group where all the switches in that group can be operated by the fingers or thumb of one hand of the second user and by placing all the other switches which are used for other functions in a separate group which can all be operated by the fingers or thumb of the other hand of the second user. Further means for minimising the number of errors made by the second user is provided in the current device by arranging the switches in a manner such that the relative positions of the switches is the same as the relative positions of the signs that each switch selects when actuated. Further means for minimising the number of errors made by the second user is provided in the current device by the use of distinguishing colours for the switch actuators such that the colour of each switch actuator is the same as the colour of the background of the sign that the switch selects when the switched is actuated.

Means for minimising fatigue for the second user is provided by positioning the switches on the current device so that they can be easily operated with fingers or thumbs of the second user without significant movement of the hand position when the device is held by the second user in a position between the first user and the second user and the second user can easily see the eyes of the first user through the aperture or window in the device.

A first method of use of the device is more particularly described as follows. The second user switches the device on using the power on/off switch. The second user holds the device in a convenient position between the first user and the second user so that the second user can clearly see the eyes of the first user through the aperture or window of the device. Initially the first user looks directly at the eyes of the second user and the second user looks directly at the eyes of the first user. In a next step the first user chooses an alpha or numeric character or symbol from the set of characters on the signs on the device and looks directly at the sign on the device that has that character imprinted or displayed on it and blinks. The eyes of the second user detect the direction of gaze of the first user and when the first user blinks the second user activates the switch on the device that has the same colour as the background of the sign at which the first user is looking. When the switch is activated the selection indicator of the sign at which the first user is looking is turned on to indicate to the first user that the second user has activated the switch. In a next step the first user looks directly at the sign that has the same colour background as the colour of the character or symbol that they chose in the first step to communicate to the second user and blinks. The second user detects the direction of gaze of the first user and when the first user blinks the second user activates the switch on the device that has the same colour as the background of the sign at which the first user is looking. When the switch is activated the selection indicator of the sign that was turned on in the previous step is turned off and the character or symbol that the first user chose to communicate is stored in the electronic memory of the device and then displayed on each of the electronic display panels on the device. The first user may then choose a next character or symbol to communicate to the second user and the steps repeated.

Repetition of these steps enables words to be displayed on the electronic display panels.

The device does not require any calibration of the device prior to or during use.

The actuators for the switches on the device that are activated by the second user when the first user blinks in the last step of the method used to communicate a character or symbol by the first user to the second user are conveniently grouped together in positions that can be easily reached by the thumb of one hand of the second user when the device is being comfortably held in a convenient position for use. In the present example of the device the actuators for the switches are arrayed with the centres of adjacent switch actuators between 10 millimetres and 25 millimetres apart and positioned along the lines of two arcs of radii between 75 millimetres and 120 millimetres with the positions of the centres of the arcs between 0 and 20 millimetres from the edge of the surface that contacts the palm of the hand when the device is being held in a convenient position for use in order to allow the thumbs of the user to operate the actuators of the switches without changing the positions of the hands. In the present example of the device the switches are positioned on the right-hand side of the device when the face of the device on which the switches are situated is facing the second user. The switches may just as conveniently be positioned on the left-hand side of the device.

Switches that have additional functions are provided on the device and are grouped together in positions that can be reached by the thumb of the other hand of the second user. In the present example of the device the actuators for the switches are arrayed with the centres of adjacent switch actuators between 10 millimetres and 25 millimetres apart and positioned along the lines of two arcs of radii between 75 millimetres and 120 millimetres with the positions of the centres of the arcs between 0 and 20 millimetres from the edge of the surface that contacts the palm of the hand when the device is being held in a convenient position for use in order to allow the thumbs of the user to operate the actuators of the switches without changing the positions of the hands.

In a first example of a function of one of the switches that provides additional functions is that a space character may be communicated between the first user and the second user and stored in the electronic memory of the device displayed on the display screen when for example the first user looks directly at the second user and blinks and the second user actuates a designated switch that provides the additional function of storing and displaying a space character. Use of spaces between words enables sentences to be stored in the electronic memory of the device and displayed on the display screen.

In a second example of a function of one of the switches that provides additional functions is that a character or phrase just displayed on the display screen may be deleted. The use of the delete function may be communicated by the first user to the second user for example by the first user looking directly at the second user and closing their eye or eyes for a brief period of time, for example one second, and the second user actuates a designated switch that provides the delete function.

In a third example of the function of one of the switches that provides additional functions is that change may be made to the selection of a sign for example if the first user wishes to change the selection of a sign they may look at directly at the second user and blink twice and when the second user activates the designated switch that provides the change function and the selected sign is deselected and the selection indicator on the sign is turned off.

In a fourth example of a function of one of the switches that provides additional functions is that activation may be made of a set-up mode for the device that may be used by the second user to change the device settings and modes of operation when a designated switch is actuated.

In an example of the first method of the use of the device the first user may choose to communicate the letter A to the second user. The first user looks at the sign that has the letter A imprinted or displayed on it and blinks. The second user detects the direction of gaze of the first user and, when the first user blinks, activates the switch that has the same colour as the background colour of the sign that the first user is looking at. The selection indicator of the sign that the first user is looking at is turned on when the switch is activated. In a next step the first user looks at the sign that has the same background colour as the letter A and blinks. The second user detects the direction of gaze of the first user and when the first user blinks activates the switch that has the same colour as the background colour of the sign that the first user is looking at. The selection indicator that was turned on in the previous step is automatically turned off and the letter A is stored in the electronic memory of the device and displayed on each of the display panels on the device.

In a second method of the use of the device a phrase in a library of phrases stored within the electronic memory of the device may be chosen and displayed on the display screen. In this example, the first user communicates to the second user a combination of an alpha character followed by a numeric character. An example of the use of this second method of the use of the device may be the communication of the combination T1 by the first user to the second user and the phrase I AM THIRSTY is displayed on the electronic display panels.

In a third method of the use of the device the second user may ask the first user a question and the first user may choose to communicate a graphic symbol such as [symbol] to communicate an affirmative response or [symbol] to indicate a negative response.

The characters and symbols and phrases are stored in the electronic memory of the device in such a manner that they can be displayed or output in the same sequence as they were chosen by the first user.

The device may be set in a set-up mode by activation of a switch by a user. In set up mode the device may be configured to perform additional or alternative functions.

In a first example of an additional or alternative function is the device may be connected by means of wires or by means of radio waves or by other means to another device such as a computer and the phrases stored in the electronic memory of the device may be changed to provide phrases that are particularly useful to particular users.

In a second example of an additional or alternative function change may be made to the language of the phrases in the library of phrases stored in the electronic memory of the device and/or the language of the information displayed on the display panels when the device is put into the set-up mode of operation.

In a third example of an additional or alternative function is the device may be connected to another device such as a computer and the phrases stored in the electronic memory of the device may be changed to provide additional alpha characters when the device is being used to communicate in languages that have characters that are not included on the signs on the device. In this example communication of O1 by the first user to the second user may result in the display of the character Ö on the electronic display panels and communication of O2 by the first user to the second user may result in the display of the character Ø on the electronic display panels.

In a fourth example of an additional or alternative function is the device may be connected by means of wires or by means of radio waves or by other means to another device such as a computer and the characters are additionally displayed on a computer screen.

In a fifth example of an additional or alternative function is the device may be connected by means of wires or by means of radio waves or by other means to another device such as a computer and the characters input into a computer program such as a word processor in addition to being displayed on the electronic display panels of the device or download data from a computer program and stored in the electronic memory of the device or displayed on the electronic display panels.

In a second preferred embodiment of the device at least one of the signs at the top left-hand corner, centre of the top edge, top right hand corner, bottom left-hand corner, centre of the bottom edge, right-hand bottom corner centre of the left-hand edge and centre of the right-hand edge may be electronic displays. The symbols that are displayed on the signs when embodied as electronic displays may be changed when the device is in set-up mode to display an alternative set of symbols. Additionally the set of symbols displayed on at least one of the signs may be changed during the course of communication by the communication for example of a single alpha character and single numeric character such as S2 to indicate that the second user shall activate a switch that has a function that changes at least one of the sets of symbols displayed on at least one of the signs. In one example the alternative symbols may be alpha characters of the alphabet of a particular language. In another example the symbols may be graphic representations of activities. In another example the symbols may be graphic representations of food items. In another example the symbols may be the characters of the Cyrillic alphabet. The symbols that may be displayed on the signs when they are electronic displays may be stored in a library of symbols in the electronic memory of the device and selected and changed by the user when the device is in set-up mode.

1. Electronic eye-pointing assisted alternative and augmented communications device that provides means for storing in electronic memory contained within the device the symbols and alphanumeric characters communicated by the sequential selection of signs on the device.

2. A device as claimed in claim 1 that has an aperture or a window through which the users may clearly see the eyes of each other when the device is held in the normal position of use.

3. A device as claimed in claim 2 that has signs displaying symbols that are arrayed around the aperture or window in the positions of top left-hand corner, centre of the top edge, top right-hand corner, bottom left-hand corner, centre of the bottom edge, right-hand bottom corner centre of the left-hand edge and centre of the right-hand edge of the aperture or window in order that they may be clearly indicated by the direction of gaze of a first user to a second user who is looking through the aperture or window at the first user with the device held in the normal position for use without the first user moving their head.

4. A device as claimed in claim 3 where at least one of the signs is an electronic display.

5. A device as claimed in claim 4 where the symbols displayed on the displays may be changed when the device is operated in set-up mode.

6. A device as claimed in claim 5 where the set of symbols displayed on the display may be changed to an alternative set of symbols by a user activation of a switch during use of the device.

7. A device as claimed in claim 6 where the selection of a sign is confirmed by a user activation of a switch on the device.

8. A device as claimed in claim 7 where the selection of a sign is indicated by the activation of a selection indicator visible on or through the sign when the selection of the sign is confirmed.

9. A device as claimed in claim 8 where the colour of the actuator of each of the switches used to operate the selection of the signs have the same colour as the background colour of the sign that the switch selects when the switch is operated.

10. A device as claimed in claim 9 where the positions of the switches used to operate the selection of the signs relative to each other is the same as the relative positions of the signs that they select.

11. A device as claimed in claim 10 that provides means for the communication of phrases in a library of phrases stored in the electronic memory of the device by the sequential selection of signs on the device.

12. A device as claimed in claim 11 that provides means for the display of the symbols alphanumeric characters and phrases communicated using the device in the order they were communicated on a display on the device.

13. A device as claimed in claim 12 that provides means for the phrases in the library of phrases stored in the electronic memory of device to be changed by the user.

14. A device as claimed in claim 13 that provides means for transfer of symbols alphanumeric characters and phrases communicated by the sequential selection of signs on device to other devices such as computers.

15. A device as claimed in claim 14 that provides means for the display of the symbols alphanumeric characters and phrases communicated using the device in the order they were communicated on a display on another device such as the display of a computer.

16. A device as claimed in claim 15 that does not require any calibration prior to or during use.

17. A device as claimed in claim 16 that the device is shaped and proportioned and the handles used for holding the device are positioned and shaped such that when the device is held in the normal position for use the arms of the user may be rested against the body of the user.

18. A device as claimed in claim 17 that has actuators for the operating switches arrayed with the centres of adjacent switch actuators between 10 millimetres and 25 millimetres apart and positioned along the lines of two arcs of radii between 75 millimetres and 120 millimetres with the positions of the centres of the arcs between 0 and 20 millimetres from the edge of the surface that contacts the palm of the hand when the device is being held in a convenient position for use in order to allow the thumbs of the user to operate the actuators of the switches without changing the positions of the hands.

19. A device as claimed in claim 18 that provides means for change by the user of the language used for communication when using the device.

20. A device as claimed in claim 19 that is powered by a battery or batteries.
